(19) United States
(12) Patent Application Publication
(10) Pub. No.: US 2005/0048187 A1
(43) Pub. Date: Mar. 3, 2005

(54) Shortening system

(76) Inventor: Jim Doucet, Olathe, KS (US)

Correspondence Address: FROMMER LAWRENCE & HAUG, 745 FIFTH AVENUE- 10TH FL., NEW YORK, NY, 10151, US

(21) Appl. No.: 10/861,831

(22) Filed: Jun. 4, 2004

Related U.S. Application Data
(60) Provisional application No. 60/475,590, filed on Jun. 4, 2003.

(51) Int. Cl. A23D 7/00

(52) U.S. Cl. 426/601

(57) ABSTRACT

A shortening system, such as a spray shortening system; for instance, a shortening system containing unhydrogenated or non-hydrogenated vegetable oil, such as a highly unsaturated, non-hydrogenated or unhydrogenated vegetable oil, e.g., soybean oil or canola oil and a minimum or minor amount (e.g., by weight about 3-10%, advantageously about 3-7%, more advantageously about 3-6% or about 3-5% or less than about 6% or less than about 8%) of conserved trans monoglyceride and/or diglyceride, advantageously a monoglyceride or a mono-and diglyceride that is mostly monoglyceride, based on a highly unsaturated oil, such as a highly unsaturated vegetable oil, e.g., canola or soybean oil, which has been selectively and partially hydrogenated so as to result in conservation of the geometric isomer of the C18:1 ester, namely the C18:1t or elaidic ester, as well as to methods for making and using such a shortening system, products from the use of such a shortening system, and the monoglyceride and/or diglyceride constituent of the shortening system, and methods for making and uses thereof.

### RELATED APPLICATIONS/INCORPORATION BY REFERENCE

This application claims priority to U.S. provisional application Ser. No. 60/475,590 filed Jun. 4, 2003, the contents of which are hereby expressly incorporated herein by reference. Various documents are cited in this text. Each of the documents cited herein (herein cited documents), and each of the documents cited in each of the herein cited documents, together with any manufacturer's specifications, data sheets, descriptions, product literature, instructions and the like for any products mentioned herein or in herein cited documents or in documents cited in herein cited documents, is hereby incorporated herein by reference. None of the documents incorporated by reference into this text is admitted to be prior art with respect to the present invention, but, documents incorporated by reference into this text may be employed in the practice of the invention.

### BACKGROUND

Fatty acids are composed of a carboxyl group and a hydrocarbon chain. Individual fatty acids are distinguished from one another by the nature of the hydrocarbon chain. This chain can vary in length from 4 to 24 carbon atoms and can be saturated, monounsaturated (one double bond, MUFA) or polyunsaturated (two or more double bonds, PUFA). The most common fatty acids in edible oils and fats are those containing 18 carbons. These include: stearic acid (a saturated fatty acid), oleic acid (a monounsaturated fatty acid), and linoleic and linolenic acids (polyunsaturated fatty acids containing two and three double bonds, respectively). The configuration of octadecanoic fatty acids is as follows:

| Formula | Common Name | Abbreviation |
|---|---|---|
| 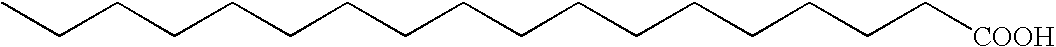 | Stearic | 18:0 |
| 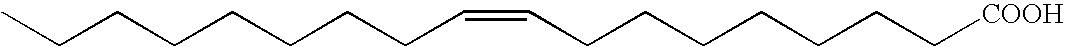 | Oleic | 18:1 n-9 cis |
| 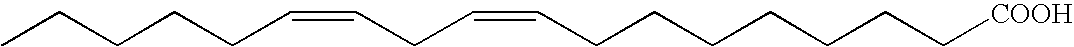 | Linoleic | 18:2 n-6 cis |
| 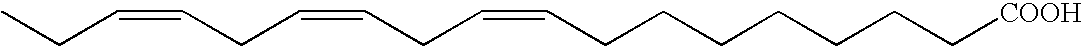 | Linolenic | 18:3 n-3 cis |
| 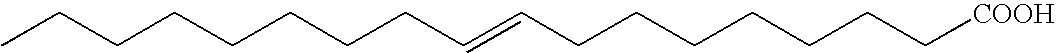 | Elaidic | 18:1 n-9 trans |

Fatty acid abbreviations are made according to the number of carbon atoms in the molecule and the number of cis ethylenic double bonds. The general assumption is that all multiple double bonds are methylene-interrupted. The chemical nomenclature requires that carbon atoms be counted from the carboxyl end of the fatty acid. However, for biological activity carbon atoms are numbered from the terminal methyl group to the first carbon of the ethylenic bond. Such a classification is designated by the symbol \tilde{ω}-x, \tilde{ω}x, or n-x, where x denotes the position of the double bond closest to the terminal methyl group. For example, linoleic acid with two double bonds, where one is located on the sixth carbon atom counted from the methyl group, will be abbreviated as C18:2n-6.

In the case of unsaturated fatty acids, the carbon chain is bent into a fixed position at the double bond, resulting in several possible geometric isomers. When the portions of the chain are bent towards each other they are called cis; and when bent away from each other, trans. The natural configuration of fatty acids is cis, as shown for oleic acid. The corresponding trans configuration, elaidic acid, results in a straight chain.

Currently in the U.S., partially hydrogenated fats are employed in the production of many chemically leavened and yeast-raised bakery products (e.g., cakes, crackers, cookies). The partial hydrogenation of domestic oils originating from soybean, cottonseed, corn, sunflower, and/or canola allow the chemical reduction of the unsaturated fatty acids to saturated fatty acids which provide greater oxidative stability.

Hydrogenation is a physical modification of these liquid oils, imparting thereto a solid fat content and an increased melting point, as saturated fatty acids are solid at room temperature whereas unsaturated fatty acids are liquid at room temperature As a result, the oils which are naturally liquid can be transformed into a semi-solid fat with a particular melting profile. To provide maximum eating pleasure with this form of the fats, the hydrogenation process of these fats is highly controlled and allowed to proceed only partially, that is, to allow only some of the unsaturated fatty acids and/or bonds thereof to be reduced to the saturated form. These types of fats and fatty acids are called “partially hydrogenated fats” or “partially hydrogenated oils” or “partially hydrogenated fatty acids”.

In addition to the reduction of the unsaturated fatty acids to the saturated form, in partial hydrogenation, a side reaction occurs in which the natural form of the unsaturated bond (referred to as a cis isomer) will twist in the plane, to form what is referred to as a trans isomer of the bond of the of the unsaturated fatty acid.

Generally, cis isomers are those naturally occurring in food fats and oils. Although very small amounts of trans isomers occur in fats from ruminants or can result from the deodorization step in refining of vegetable fats and oils, most trans isomers result from the partial hydrogenation of fats and oils. Also, it is possible for the unsaturated bond to move laterally along the fatty acid chain and this is referred to as a positional isomer. These isomers are formed at the high temperatures (e.g., 180°-240° C.) common during the hydrogenation reaction and when the Nickel catalyst typically employed during the hydrogenation reaction unsuccessfully introduces a hydrogen atom to both sides of the unsaturated bond. These isomers are rather stable and will then remain unless the hydrogenation reaction is continued until there is a complete reduction of the unsaturated fatty acids. Therefore, partially hydrogenated fat will always contain some proportion of these positional and geometrical isomers; and, those isomers, especially those that do not naturally occur in fats, can present problems.

For instance, typically, shortenings employed in bakery products may contain 15-35% trans isomers. The use of these isomers has become more scrutinized by nutritional science in the last several years. There have been clinical studies reporting observed negative health effects correlated to the presence of trans fatty acids formed during the partial hydrogenation of oils, e.g., a positive correlation with coronary heart diseases an increase in the ratio of plasma low density lipoproteins (LDL) to high density lipoproteins (HDL) and thus a possible increase in the risk of coronary heart disease (see, e.g., Elias, B. A., Food Ingredients Europe: Conference proceedings, London, October 1994 (Publisher: Process Press Europe, Maarssen); Willet, W. C. et al., Lancet 341 (8845); 581-585 (1993); Khosla, P. et al., J. Am. Col. of Nutrition, August 1996, 15(4):325-339 (American College of Nutrition, NY, N.Y.)).

However, not all trans fatty acids are necessarily “bad”; and, other, including more recent, studies have shown that trans fatty acids may not have such a correlation with coronary heart disease and/or may be akin to saturated fatty acids, fats or oils. Cf. Clarke et al., “Dietary lipids and blood cholesterol: quantitative meta-analysis of metabolic ward studies” BMJ 1997;314:112 (11 January) (Forty solid food experiments provided information on dietary intake of trans monounsaturated fats, mainly trans C18:1; elaidate: trans fatty acids account for only 2% of calories in the British diet, so replacing half isocalorically by carbohydrates would be expected to reduce blood total cholesterol by only 0.05 (0.01) mmol/l; however, intake of monounsaturated fat had no significant effect on total or low density lipoprotein cholesterol despite raising high density lipoprotein cholesterol by about as much as polyunsaturates; “combined effect of changing the type, but not the amount, of dietary fat by replacement of 10% of dietary calories from saturates by monounsaturates (5%) and by polyunsaturates (5%), together with consuming 200 mg less dietary cholesterol, would be a reduction in blood cholesterol of about 0.8 mmol/l, with the reduction chiefly in low density lipoprotein cholesterol”); Khosla et al. “Replacing Dietary Palmitic Acid with Elaidic Acid (t-C18:1Δ9) Depresses HDL and Increases CETP Activity in Cebus Monkeys,” The Journal of Nutrition Vol. 127 No. 3 March 1997, pp. 531S-536S (palmitic acid- and elaidic acid-rich diets produced identical effects on LDL metabolism in normocholesterolemic cebus monkeys fed diets with low levels of cholesterol); McMillan et al. “Elaidinized olive oil and cholesterol atherosclerosis,” B. I. Arch. Pathol. 76:106-12 (1963) (in rabbits trans fatty acids have been shown to raise cholesterol levels but do not increase the severity of atherosclerosis); van de Vijver et al. “Trans unsaturated fatty acids in plasma phospholipids and coronary heart disease: a case-control study,” Atherosclerosis 1996 Sep 27;126(1):155-61 (no significant correlations were found between percentages of trans fatty acids in plasma phospholipids and plasma LDL or HDL cholesterol levels; findings do not support an association between trans fatty acid intake and risk for coronary heart disease); van de Vijver et al. “Association between trans fatty acid intake and cardiovascular risk factors in Europe: the TRANSFAIR study,” Eur J Clin Nutr 2000 Feb;54(2):126-35 (while high intakes of trans fatty acids (TFA) have been asserted by others to exert an undesirable effect on serum lipid profiles, no associations were found between total TFA intake and LDL, HDL or LDLUHDL ratio after adjustment for cardiovascular risk factors; additional adjustment for other fatty acid clusters resulted in a significant inverse trend between total TFA intake and total cholesterol (Ptrend<0.03)—the most abundantly occurring TFA isomer, C18:1t, contributed substantially to this inverse association; and, at the current European intake levels of trans fatty acids they are not associated with an unfavorable serum lipid profile).

Furthermore, it is important to note that the majority of trans isomers formed during partial hydrogenation of vegetable oils and fats are in different positions along the fatty-acid backbone (primarily elaidic) than those that occur naturally in animal fats (vaccenic) and that fats from ruminants reportedly account for 20% to 25% of TFA (trans fatty acid) intake. Thus, trans fats from animal and vegetable sources may present different associations with risk factors for heart disease.

Accordingly, as there seems to be reports weighing in on both sides of the “trans fat issue”, and the source of the trans fat—animal vs. vegetable—may impact upon risk factors, there may there may be a problem in the art in the use of large or significant amounts of partially hydrogenated fats and oils in food products; and, the American Heart Association recommends using naturally occurring unhydrogenated oil when possible.

Moreover, the problems presented by partially hydrogenated fats or oils cannot be addressed by merely employing naturally saturated fats or oils; and, the use of naturally saturated fats and oils present problems.

For instance, as many nutritionists caution against replacing TFAs in the diet with saturates, it is now not recommended to substitute trans fats and oils with saturated fats and oils; and, the substitution may result in little biological significance (see literature cited supra). Indeed, saturated fatty acids may cause greater health issues than TFAs as saturated fatty acids may raise total cholesterol mostly due to an increase in low-density lipoprotein (LDL) cholesterol from saturated fatty acids.

Another possible replacement for partially hydrogenated fats or oils is interesterified fats based on liquid oils and fully hydrogenated fats. These interesterified fats are from a process wherein the fatty acids on the triglycerides of two fats are randomized, resulting in a triglyceride composition that can provide a suitable melting profile.

This option presents problems insofar as the food manufacturer or processor would be required to include the fully hydrogenated fat on the product label, and the ultimate consumer may likely associate trans isomers with the full or complete hydrogenation process, such that the food product would likely not be commercially successful.

Polyunsaturated fatty acids are considered a highly essential component of a healthy diet according to the U.S. Food and Nutritional Board's Recommended Dietary Allowances (tenth ed. 1989) (e.g., amount of dietary linoleic acid for humans should be a minimum of 2% of dietary calories and preferably 3%; and, the requirement for linolenic acid has been estimated to be 0.54% of calories)

While it would be desirable to replace partially hydrogenated fats simply with natural vegetable oils since natural vegetable oils have a relatively high ratio of polyunsaturated to saturated fatty acids, attempts to do this so far have also proven to be quite unsatisfactory in regard to either the processing or organoleptic (e.g., taste, texture, eating) aspects of the food product. For example, there may be insufficient oil retainment in the dough or batter resulting in separation of oil. Or, oils may depart from the food product too quickly in the mouth, imparting an off-taste and off-feel to the product as it is being consumed.

Another related problem in the preparation of food products is “bloom”; a phenomenon wherein certain fats or oils permeate to the surface of a food product, such as a cookie, and leave a scoring on the surface of the food product. This “bloom” renders the food product not visually appealing and ergo not consumable. It would be desirable to provide a shortening system which does not suffer from “bloom.”

In the production of food surfactants or emulsifiers, a triglyceride is reacted with glycerol and to form a reaction product containing the desired product, the monoglycerides. Thus, the reaction product is typically subjected to a treatment to isolate a monoglycerides product from a diglycerides and triglycerides product; the diglycerides and triglycerides product is considered a by-product of the reaction of a triglyceride with a glycerol to obtain monoglycerides for surfactants or emulsifiers. The diglycerides and triglycerides product is sometimes discarded, or recycled back to a reactor wherein the reacting with glycerol is occurring so as to enhance the production of monoglycerides (see, e.g., Lauridsen, “Food Surfactants, Their Structure And Polymorphism” Technical Paper TP 2-1e Danisco Ingredients, Braband Denmark, and references cited therein).

Systems functioning as or containing fats or oils have been proposed (see, e.g., CN 1078353, U.S. Pat. Nos. 5,458,910, 5,612,080, 5,306,514, 5,306,515, 5,306,516, 5,254,356, 5,061,506, 5,215,779, 5,064,670, 5,407,695, 4,865,866, 4,596,714, 4,137,338, 4,226,894, 4,234,606, 4,335,157, 3,914,452, 3,623,888, DE 291240A). In addition, reference is made to U.S. Pat. No. 5,908,655 and EP1057887A1, and documents cited therein including, U.S. Pat. Nos. 2,132,437, 2,442,534, 3,943,259, 4,018,806, 4,055,679, 4,154,749, 4,263,216, 4,366,181, 4,386,111, 4,425,371, 4,501,764, 4,510,167, 4,567,056, 4,596,714, 4,656,045, 4,732,767, 4,889,740, 4,961,951, 5,110,509, 5,211,981, 5,316,927, 5,434,280, 5,439,700, 5,458,910, 5,470,598, 5,589,216, 5,612,080, 5,718,938, and 5,756,143; and, Feuge et al., Modification of Vegetable Oils VI: The Practical Preparation of Mono and Diglycerides, Oil and Soap, 23 (259-264), 1946; Handbook of Food Additives, 2nd Edition, vol. 1, Chapter 9, Surface Active Agents, pp. 397-429; Bailey's Industrial Oil and Fat Products, 4th Edition, vol. 2, Chapter 4, pp. 130-147; and Krog, “Interactions of Surface-Active Lipids with Water, Protein and Starch Components in Food Systems,” Technical Paper TO 3-le, Danisco Ingredients, Braband, Denmark.

However, these systems have not sufficiently addressed the problems in the art; and, these systems have not been reported to provide the synergistic, and surprisingly superior properties, including improvement in organoleptic properties of foodstuff, of the present invention. Further, these systems may not sufficiently address new or additional issues that have arisen in the art.

More in particular, currently, partially hydrogenated (PH) fats are utilized to help shorten the texture of crackers and cookies and related bakery items. Also, PH fats are utilized to coat the surface of crackers to preserve shelf life and maintain freshness. New labeling requirements (“nutritional panel issues”) for trans fats have been proposed and as a result manufacturers will attempt to conserve the level of trans by replacing the current partially hydrogenated fats with options such as: (1) Blend of fully refined oils with fully hydrogenated fats; (2) Interesterifcation of fully refined oils with fully hydrogenated oil and (3) Blends of domestic oils with tropical fats.

Disadvantages for these options would include possible functional problems or marketing issues.

For example, in options (1) or (2), the declaration of hydrogenated fats would be a marketing problem due to the association of trans fatty acids with hydrogenation. From a functional point of view, option (1) would provide high melting solids which may result in waxiness and/or dryness in the mouth, leading to poor flavor release. For option (3), the declaration of a tropic fat would be a marketing problem due to the association of saturated fats and tropic fats.

Thus, for instance, U.S. Pat. No. 5,908,655 and EP1057887A1 provide a shortening system. The shortening system comprises an admixture of at least one non-hydrogenated vegetable oil and at least one isolated stearine fraction obtainable from glycerolysis/interesterification of a fat or oil, wherein the isolated stearine fraction has an enhanced concentration of diglycerides.

In these documents, the monoglyceride of the shortening system is one which is normally solid at room temperature, or one which is a stearine fraction, or one that is with a diglyceride and is a stearine fraction or normally solid at room temperature, e.g., monoglycerides and diglycerides derived from fats and oils such as palm stearine that are high in saturated fatty acids. The marketing issue of the association of saturated fats and tropic fats is not addressed in these documents.

Further still, since monoglycerides derived from these esters have so high a melting point (greater than 65° C.), these crystals can provide delayed meltdown, and possibly the issue of waxiness. By shifting to diglycerides which have higher solubilities in fats and oil and as a result lower melting points, this issue would be reduced (and hence the preference in 5,908,655 and EP1057887A1 for diglycerides or stearine fractions having enhanced diglyceride concentrations).

Unfortunately these fats also contain appreciable amounts of polyunsaturated fats and monoglycerides and diglycerides resulting from these esters have much lower crystal integrity.

As a result, higher levels of the monoglycerides and diglycerides (e.g., 6-8% ) are employed to provide the desired effect. This is not a minor amount of monoglyceride and/or diglyceride. Accordingly, this does not adequately address the issues in the art.

It would be advantageous and an advance in the art to provide a shortening system, such as a spray shortening system, that addresses issues in the art and is useful for the coating of bakery or baked products, such as savory crackers.

### OBJECTS AND/OR SUMMARY OF THE INVENTION

In view of the state of the literature on TFAs and the caution against replacing TFAs with saturates, the use of a minor amount of a monoglyceride and/or diglyceride containing or consisting essentially of or consisting of TFA, for example, to improve the organoleptic and physical properties of a non-hydrogenated or highly unsaturated vegetable oil, may address issues in the art, without presenting a significant health risk (See also van de Vijver et al. 1996, supra; van de Vijver et al. 2000, supra). Moreover, as demonstrated herein, inventive shortening systems with a conserved amount of trans fat, can provide overall less trans fat than hydrogenated fats or oils, and an advantageous nutritional panel; and thus, the present invention can even address the “trans fat issue”, if it is an issue, as well as nutritional panel issues.

Indeed, it would be advantageous and an advance in the art to provide a shortening system that contains, or consists essentially of, or consists of, an unhydrogenated or non-hydrogenated, highly unsaturated, vegetable oil, e.g., sunflower oil, soybean oil, corn oil, cottonseed oil, safflower oil, canola oil, olive oil, or blends thereof, advantageously soybean oil, cottonseed oil, canola oil or blends thereof, and only a minor amount of a monoglyceride and/or diglyceride, advantageously a monoglyceride, based or a highly unsaturated oil, such as a highly unsaturated vegetable oil, e.g., canola or soybean oil, which has been selectively and partially hydrogenated so as to result in conservation of the geometric isomer of the C18:1 ester, namely the C18:1t or elaidic ester.

The present invention relates to a shortening system, such as a spray shortening system; for instance, a shortening system containing, consisting essentially of, or consisting of, unhydrogenated or non-hydrogenated vegetable oil, such as a highly unsaturated, non-hydrogenated or unhydrogenated vegetable oil, e.g., soybean oil or canola oil and a minimum or minor amount (e.g., by weight about 3-10%, advantageously about 3-7%, more advantageously about 3-6% or about 3-5% or less than about 6% or less than about 8%) of conserved trans monoglyceride and/or diglyceride, advantageously a monoglyceride or a mono-and diglyceride that is mostly monoglyceride, based on a highly unsaturated oil, such as a highly unsaturated vegetable oil, e.g., canola or soybean oil, which has been selectively and partially hydrogenated so as to result in conservation of the geometric isomer of the C18:1 ester, namely the C18:1t or elaidic ester, as well as to methods for making and using such a shortening system, products from the use of such a shortening system, and the monoglyceride and/or diglyceride constituent of the shortening system, and methods for making and uses thereof.

The present invention provides an isolated monoglyceride and/or diglyceride obtained or obtainable by glycerolysis/interesterification of an unsaturated oil which has been selectively and partially hydrogenated so as to result in conservation of the elaidic ester (C18:1t).

The present invention provides a process for the preparation of a monoglyceride and/or diglyceride comprising the steps of (i) selective and partial hydrogenation of an unsaturated oil so as to result in conservation of the elaidic ester (C18:1t) (ii) glycerolysis/interesterification of the selectively and partially hydrogenated unsaturated oil.

The present invention provides a shortening system comprising i) an edible oil; and ii) a monoglyceride and/or diglyceride obtained or obtainable by glycerolysis/interesterification of an unsaturated oil which has been selectively and partially hydrogenated so as to result in conservation of the elaidic ester (C18:1t); wherein the monoglyceride and/or diglyceride is present in a minor amount.

It will be appreciated by one skilled in the art that during selective and partial hydrogenation of the unsaturated oil the trans isomer of the C18:1 ester may be formed rather than simple reduction of the unsaturated ester. Thus it will be appreciated that by the conservation of the C18:1t ester refers not only to conservation of any C18:1t ester present in the unsaturated oil but also to conservation of C18:1t ester formed during the selective and partial hydrogenation.

It will also be appreciated by one skilled in the art that conservation of the trans form C18:1 ester (C18:1t) must result from conservation of the unsaturation of the ester, the positional isomer of the ester and the geometric isomer of the ester. If any one of (a) the degree of unsaturation, (b) the position of the unsaturation (the positional isomer) or (c) the geometric configuration of the isomer, were to change the compound would be other than an elaidic ester (C18:1t) and the elaidic ester (C18:1t) would not be conserved.

The present invention envisages that not only is the ester form of the elaidic ester (C18:1t) conserved but also elaidic acid (C18:1t) present as free acid in the unsaturated oil during selective and partial hydrogenation is also conserved.

The inventive shortening composition may be prepared by the physical blending or admixing of the components (the non-hydrogenated vegetable oil and the mono- and diglycerides or the stearine fraction thereof, preferably with mechanical agitation. The mono- and diglyceride is preferably heated to an elevated temperature sufficient to provide liquidity, e.g., to within plus or minus 10° C. of its melting point, and is then added directly into the non-hydrogenated liquid vegetable oil. Blending is continued until the mono- and diglyceride is completely in solution, i.e., completely dissolved into the non-hydrogenated liquid vegetable oil. The inventive shortening composition can then be added directly into a foodstuff at this temperature, or cooled prior to use in a foodstuff, depending upon the use. The inventive shortening composition is advantageously used as a liquid, e.g., as a spray, or in an aerosol or atomized form. Thus, after preparation, the inventive shortening composition can be stored at a temperature to maintain it in a liquid state, i.e., to maintain the solution; and it can be used directly in the preparation of a foodstuff at or below the temperature required to maintain the solution. In addition, the liquid state of the inventive shortening composition can be rapidly cooled to a temperature of about 65-90° F. (about 18°-32° C.) to initiate the formation of dispersed fat crystals in the oil prior to adding to other ingredients of a foodstuff.

For instance, the shortening system advantageously contains, or consists essentially of, or consists of, a minor amount of the monoglyceride and/or diglyceride, such as, by weight (based on the total weight of the composition or system) about 3-about 10% or about 3- about 7% or about 4- about 6% or about 5%; or, less than 6-8% of the monoglyceride and/or diglyceride, for example, less approximately 6% or less than approximately 8%, such as from about 1% or about 2% or about 3% to about 5% or about 7% or less than 6% or less than 8%, e.g., about 2% or about 3% or about 4% to approximately 5%.

The shortening system similarly advantageously comprises, consists essentially of, or consists of, the unsaturated or unhydrogenated or non-hydrogenated, advantageously highly unsaturated and non-hydrogenated oil, in an amount by weight (based on the total weight of the composition or system), of more than 94-92%, or of about 97% to about 90%, or of about 97% to about 93%, or of about 96% to about 94%, or of about 95%, or of more than approximately 94%, or of more than approximately 92%; such as a system containing, or consisting essentially of ,or consisting of, by weight (based on the total weight of the composition or system) from about 99% to about 95% of the oil, or, about 98% to about 95% of the oil, or, about 97% to about 95% of the oil, or, about 99% to about 93% of the oil, or, about 98% to about 93% of the oil, or, about 97% to about 93% of the oil, or about 96% to about 93% of the oil, or about 95% to about 93% of the oil, or, about 99% to about 94% of the oil, or, about 98% to about 94% of the oil, or, about 97% to about 94% of the oil, or of about 97% to about 95% of the oil; such as more than 92%, more than 94%, about 93%, e.g., about 99% or about 98% or about 97% or about 96% or approximately 95% oil. The shortening system preferably contains less monoglyceride and/or diglyceride than the amount of the stearine fraction employed in shortening system of U.S. Pat. No. 5,908,655 and EP1057887A1. Advantageously, the oil and monoglyceride and/or diglyceride are matched to each other. By the term “matched to each other” it is meant that for instance, if the oil of the shortening system is canola oil, the monoglyceride and/or diglyceride is based upon or of canola oil; but, the source of the mono- and diglyceride need not match the oil, e.g., fully refined oil. The monoglyceride and/or diglyceride is advantageously obtained from the glycerolysis of a fat or oil.

The shortening system is preferably a two-component system; namely that as a first component there is the oil and as a second component there is the monoglyceride and/or diglyceride. However, while the inventive shortening system is advantageously a two-component system, it can be used with additional ingredients that are typically employed in shortening systems, with the understanding that such additional ingredients are not to detract from the novel or basic characteristics of the invention and are not to extend to embodiments found in the prior art.

Thus, for instance, while the inventive shortening system is advantageously a two-component system, it can be used with or contain or consist essentially of or consist of additional ingredients typically employed in or with shortening systems, such as an antioxidant system, e.g., any desired antioxidant system, such as tocopherol, TBHQ, BHT, or propyl gallate, alone or in combination with metal scavengers such as citric acid, phosphoric acid, EDTA and the like, to increase the stability of the shortening system against oxidative reactions. Such antioxidants are used in amounts typically used in the art, e.g., about 0.05%-about 3%, for instance, about 1%-about 3%, such as about 2%, by weight of the total composition or system.

The monoglyceride and/or diglyceride or mono-and diglyceride of the shortening system advantageously comprises, or consists essentially of, or consists of, a minimum monoglyceride content of greater than about 45% by weight, such as greater than about 50% by weight, for instance, greater than about 55% by weight, e.g., greater than about 60% by weight, advantageously greater than about 65% by weight, preferably greater than about 70% by weight, such as greater than about 75% by weight, for instance, greater than about 80% by weight, e.g., greater than about 85% by weight, even more advantageously greater than about 90% by weight, e.g., greater than about 92% by weight, such as greater than about 95% by weight, most advantageously a product that is considered a monoglyceride. Thus, it can be said that it is preferred that the monoglyceride and/or diglyceride be predominantly monoglyceride, or more preferably, monoglyceride.

The monoglyceride and/or diglyceride or mono-and diglyceride of the shortening system advantageously comprises, or consists essentially of, or consists of, a content of glycerol mono elaidate (18:t) by weight of about 25-about 70%, for instance, about 30-about 70%, such as about 35-about 70% or about 40-about 70% or about 45-about 70%; or, for example about 25-about 60%, such as about 30-about 60% or about 35-about 60%, advantageously about 40-about 60% or about 45-about 60%, such as about 50% or more than or greater than about 50%, e.g., up to about 70%.

The monoglyceride and/or diglyceride or mono-and diglyceride of the shortening system advantageously comprises, or consists essentially of, or consists of, a content of saturated monoglycerides (e.g., glycerol monostearate, glycerol monopalmitate, and combinations thereof) by weight of about 10-about 40%, for instance, about 15-about 40%, such as about 20-about 40% or about 25-about 40% or about 25-about 30%; or, for example about 10 or about 15-about 35%, such as about 20-about 35% or about 25-about 35%, such as about 10 or about 15 or about 20-about 30% or about 25%.

Thus, in a further embodiment the invention provides a method for preparing a shortening composition comprising admixing an aforementioned monoglyceride and/or diglyceride obtainable from or obtained from the glycerolysis/interesterification of a triglyceride or at least one monoglyceride and/or diglyceride, e.g., mono- and diglycerides from glycerolysis/interesterification having the aforementioned properties, with vegetable oil, advantageously an unhydrogenated or non-hydrogenated, highly unsaturated vegetable oil, e.g., sunflower oil, soybean oil, corn oil, cottonseed oil, safflower oil, canola oil, olive oil, or blends thereof, advantageously soybean oil, cottonseed oil, canola oil or blends thereof, advantageously soybean oil or canola oil. In another embodiment the invention comprises a method for preparing a shortening system or composition comprising: subjecting a triglyceride to glycerolysis/interesterification; isolating a monoglyceride and/or diglyceride obtainable from or obtained from the glycerolysis/interesterification and having the aforementioned properties, and admixing the isolated monoglyceride and/or diglyceride obtainable from the glycerolysis/interesterification of a triglyceride with vegetable oil, e.g., sunflower oil, soybean oil, corn oil, cottonseed oil, safflower oil, canola oil, olive oil, or blends thereof, advantageously soybean oil, cottonseed oil, canola oil or blends thereof, advantageously soybean oil or canola oil. Thus, the invention comprehends an isolated monoglyceride and/or diglyceride or mono-and diglyceride having the aforementioned properties, advantageously obtained from or obtainable from the glycerolysis/interesterification of a triglyceride.

Accordingly, the invention comprehends a monoglyceride and/or diglyceride or mono- and diglyceride comprising, or consisting essentially of, or consisting of, a minimum monoglyceride content of greater than about 45% by weight, such as greater than about 50% by weight, for instance, greater than about 55% by weight, e.g., greater than about 60% by weight, advantageously greater than about 65% by weight, preferably greater than about 70% by weight, such as greater than about 75% by weight, for instance, greater than about 80% by weight, e.g., greater than about 85% by weight, even more advantageously greater than about 90% by weight, e.g., greater than about 92% by weight, such as greater than about 95% by weight, most advantageously a product that is considered a monoglyceride. Thus, it can be said that it is preferred that the monoglyceride and/or diglyceride be predominantly monoglyceride, or more preferably, monoglyceride. (One skilled in the art can determine the monoglyceride content of a mono-and diglyceride composition, without undue experimentation, e.g., from documents cited in or incorporated by reference into this disclosure and the knowledge in the art; for instance, using gas chromatography, infra-red spectroscopy/spectrophotometry and other analytical procedures.)

The invention likewise comprehends a monoglyceride and/or diglyceride or mono-and diglyceride comprising, or consisting essentially of, or consisting of, a content of glycerol mono elaidate (18:1t) by weight of about 25-about 70%, for instance, about 30-about 70%, such as about 35-about 70% or about 40-about 70% or about 45-about 70%; or, for example about 25-about 60%, such as about 30-about 60% or about 35-about 60%, advantageously about 40-about 60% or about 45-about 60%, such as about 50% or more than or greater than about 50%, e.g., up to about 70%. (One can determine the amount of trans unsaturation of fatty acids without any undue experimentation, from documents cited herein or incorporated herein by reference and the knowledge in the art, see, e.g., Ratnayake, “Determination of trans unsaturation by infrared spectrophotometry and determination of fatty acid composition of partially hydrogenated vegetable oils and animal fats by gas chromatography/infrared spectrophotometry: collaborative study,” J AOAC Int 1995 May-Jun;78(3):783-802.)

The invention similarly comprehends a monoglyceride and/or diglyceride or mono-and diglyceride comprising, or consisting essentially of, or consisting of, a content of saturated monoglycerides (e.g., glycerol monostearate, glycerol monopalmitate, and combinations thereof) by weight of about 10-about 40%, for instance, about 15-about 40%, such as about 20-about 40% or about 25-about 40% or about 25-about 30%; or, for example about 10 or about 15-about 35%, such as about 20-about 35% or about 25-about 35%, such as about 10 or about 15 or about 20-about 30% or about 25%. (One skilled in the art, can determine the content of saturated monoglycerides (e.g., glycerol monostearate, glycerol monopalmitate, and combinations thereof) in a mono-and diglyceride composition, without undue experimentation, e.g., from documents cited in or incorporated by reference into this disclosure and the knowledge in the art; for instance, using gas chromatography, infra-red spectroscopy/spectrophotometry and other analytical procedures.)

The mono-and diglyceride of the invention can be used in the same fashion as other mono-and diglycerides.

The monoglyceride and/or diglyceride or mono-and diglyceride, including its amount and properties (e.g., constituents), in the shortening system of the invention provides stabilization of the liquid oil in the shortening system, e.g., by the formation of a crystalline network that entrains and suspends liquid oil.

The shortening system advantageously provides favorable mouth feel attributes, such as clean get a way, melt down, and flavor release.

Furthermore, the shortening system advantageously allows the ingredient declaration of the ultimate food product to avoid the listing of hydrogenated fats or oils, or tropical fats or oils such as palm oil, or of fats or oils that are highly saturated. That is, the ultimate food product need not list in its ingredient declaration hydrogenated fats or oils, or tropical fats or oils such as palm oil, or of fats or oils that are highly saturated, due to the shortening system; a clear advantage over that which has come before, such as U.S. Pat. No. 5,908,655 and EP1057887A1 and other prior documents in the art that do not necessarily seek to avoid the necessity to list or declare such ingredients (and indeed, certain documents in the art may even direct towards the use of hydrogenated fats or oils, or tropical fats or oils such as palm oil, or of fats or oils that are highly saturated or of a stearine fraction, in contrast to the instant invention).

The inventive shortening system allows for the conservation of trans fats or oils, as well as advantageously the conservation of saturated fats.

The present invention also provides a shortening system comprising, or consisting essentially of, or consisting of, an admixture of at least one hydrogenated vegetable oil and at least monodiglyceride and/or diglyceride comprised predominantly of mono unsaturated acyl fatty acids (18:1c (cis) & 18:1t), e.g., an aforementioned mono-and diglyceride of the invention, in combination with at least one saturated acyl fatty acid. This shortening system can be employed in accordance with any herein discussion of uses for or of a shortening system or composition. This shortening system advantageously contains, based on weight of the total composition, about 3% to about 10% of the mono-and diglyceride, e.g., about 3% to about 7%, such as about 3% or about 4% or about 5% or about 6% of the mono-and diglyceride.

Vegetable oils high in polyunsaturation such as soybean oil, canola oil, are advantageous to employ in the practice of the invention; and, in certain embodiments, such oils that have been partially and selectively hydrogenated may be employed.

The invention allows for the stabilization and entrainment of liquid oil in crackers, cookies, bread, and related baked goods. Thus, the invention provides for uses of the shortening system and monoglyceride and/or diglyceride of the invention.

Furthermore the invention allows for the coating of cereals to increase shelf life of the cereal. In cereal applications the cereal are formulated and then formed or extruded with the possibility of toasting, baking or the like. Immediately following this step, the cereal is coated with a spray oil to congeal on the surface providing increased shelf life. Typically partially hydrogenated fats or tropical fats are utilized for this purpose. The present inventive shortening may be applied in a similar manner to form a barrier on the surface of the cereal.

Accordingly, the invention comprehends a foodstuff or food product, such as bread, a cracker, cookie or similar baked food product, cereal, tortilla such as baked tortilla (advantageously soft), taco, toaster pastry, pie dough or good that contains or has been coated with the shortening system of the invention, as well as means for preparing such a foodstuff or food product comprising, consisting essentially of or consisting of coating the foodstuff or food product. Thus, the invention comprehends an improved method for preparing such a foodstuff or food product comprising or consisting essentially of or consisting of coating the foodstuff or food product with or topically applying to the foodstuff or food product an inventive shortening system, as well as improved methods for improving or increasing shelf life or for improving or enhancing organoleptic properties or mouthfeel or taste of such a foodstuff or food product comprising or consisting essentially of or consisting of coating the foodstuff with or topically applying to the foodstuff or food product an inventive shortening system. Advantageously, the coating or topical application is performed after baking the foodstuff or food product, and prior to any packaging. Thus, an improvement in the preparation and packaging of such a foodstuff or food product is coating the foodstuff or food product with, or topically applying to the foodstuff or food product, after baking and before packaging, an inventive shortening system.

More in particular, shortenings are employed both in the formulation of snack crackers, cookies, and similar baked food products and as a coating on the surface thereof after baking. After baking, such as a short time after baking or immediately after baking, advantageously while the crackers, cookies, etc. are still hot or warm, shortening system of the invention (spray oil) is topically applied to the entire surface on a weight basis of about 10-about 20%, e.g., about 12-about 18%, such as about 15%. This spray oil serves to improve and preserve the cracker's or cookie's mouth profile concerning texture/flavor release; and, of course, its overall appearance, as well as its stability (e.g., shelf life).

Further, the inventive shortening system can be used as a delivery system for an emulsifier. For use as a delivery system for food emulsifiers, the inventive shortening composition is typically combined by physical blending (admixing) with the emulsifier. Typical emulsifiers which can be blended with the shortening system include lecithin, diacetylated tartaric acid esters of mono-diglycerides (DATEM), sodium stearoyl lactylate (SSL) and the like (see, e.g., N. Krog, “Interactions of Surface-Active Lipids With Water, Protein and Starch Components In Food Systems,” Technical Paper TP 3-1e, Danisco Ingredients, Braband, Denmark). And thus, the invention comprehends an emulsifier delivery system comprising: an inventive shortening system admixed with an emulsifier. The amount of emulsifier used is the same as the amount of emulsifier typically used when shortening is a vehicle for delivery of an emulsifier; and, the skilled artisan can arrive at a suitable amount of emulsifier for use in this aspect of the invention, without undue experimentation, from this disclosure and, documents cited herein or incorporated herein by reference, and the knowledge in the art.

Thus, the invention comprehends a foodstuff containing the inventive shortening system or having been prepared with the inventive shortening system; and, the invention provides an emulsifier delivery system comprising the inventive shortening system.

The shortening system of the present invention provides improved organoleptic properties to foodstuff prepared with or containing the shortening system. For instance, when sprayed on crackers, the shortening system, possibly due to the synergistic amount of crystal matrices, does not “bleed off” the cracker as do other fats or oils when the cracker is placed on a surface; and, the shortening system does not separate too quickly in the mouth such that the cracker has better taste and feel in the mouth. Similarly, when employed in baked goods, i.e., when used in a recipe prior to baking and baked in a baked good or foodstuff, the shortening system does not permeate to the surface or “bloom.” By “does not ‘bleed off’” is meant that the cracker or other foodstuff is placed on a paper towel for a period of time, such as overnight, and the cracker or foodstuff leaves a negligible oil print on the paper, similar to the print left by a cracker or other foodstuff prepared using a partially hydrogenated shortening for the same period of time.

Furthermore, short chain fatty acids, such as those based upon butyric acid, raise issues such as “off flavor” or “off smell”—issues of rancidity—and, the invention, by relying upon longer carbon chains, avoids these issues too. And from the discussion herein, it is clear that the inventive shortening system is well-suited for chemically leavened or yeast-raised bakery products, as well as for cookies, crackers, and other applications where partially hydrogenated fats or oils are presently used.

It is noted that in this disclosure, terms such as “comprises”, “comprised”, “comprising”, “contains”, “containing” and the like can have the meaning attributed to them in U.S. Patent law; e.g., they can mean “includes”, “included”, “including” and the like. Terms such as “consisting essentially of” and “consists essentially of” have the meaning attributed to them in U.S. Patent law, e.g., they allow for the inclusion of additional ingredients or steps that do not detract from the novel or basic characteristics of the invention, i.e., they exclude additional unrecited ingredients or steps that detract from novel or basic characteristics of the invention, and they exclude ingredients or steps of the prior art, such as documents in the art that are cited herein or are incorporated by reference herein, especially as it is a goal of this document to define embodiments that are patentable, e.g., novel, nonobvious, inventive, over the prior art, e.g., over documents cited herein or incorporated by reference herein. And, the terms “consists of” and “consisting of” have the meaning ascribed to them in U.S. Patent law; namely, that these terms are closed ended.

These and other embodiments are disclosed or are obvious from and encompassed by, the following Detailed Description.

### DETAILED DESCRIPTION

The present invention involves a shortening system comprising or consisting essentially of or consisting of a fully refined fat such as soybean oil, cottonseed oil, canola oil, palm oil, or blends thereof, in combination with a minor amount of a monoglyceride and/or diglyceride based on an oil such as canola or soybean or of another highly unsaturated oil which has been selectively and partially hydrogenated to result in conservation of the geometric isomer of the C18:1 ester. This ester referred to as Elaidic by the common name denoted C18:1 t in combination with the saturated esters of the monoglyceride and diglycerides provide the formation of a crystalline structure that stabilizes the liquid oil.

The invention takes advantage of two effects: 1) that monoesters or monoglycerides become insoluble as the temperature of the shortening in the bakery good drops after exiting the manufacturing process; and, 2) this insolubility of the monoglyceride is further related to the nature of the acyl group, using the common nomenclature in Fats & Oils, as follows (from least insoluble to most insoluble): Linoleic (18:2 c ) <Oleic (18:1 c) <Elaidic (18:1 t)<Palmitic (16:0)<Stearic (18:0)<Arachidic (20:0)<Behenic (22:0).

As to the solubility in fats and oils, among monoglycerides, diglycerides and triglycerides, monoglycerides will have the least solubility. At a given temperature and concentration, the order of melting (or solubility) of a given acyl group as an ester in fats and oils is as follows (going from most soluble to least soluble): Triglycerides<Diglycerides<Monoglycerides.

Insolubility leads to the occurrence of supersaturation, which in turn results in nucleation, which in turn results in crystal growth. The size, number, and nature of the crystals will determine the degree of suspension and entrainment of liquid oil. This behavior relates to the solubility of the polar head group: Monoglycerides with two hydroxyl groups have the least solubility, and diglycerides with one hydroxyl group have intermediate solubility. This behavior also relates to the length of the hydrocarbon chain and to the presence of any unsaturated groups which result in a bend in the hydrocarbon chain. These attributes impact the packing of the molecules with respect to proximity (to one another).

In essence, the structure of this packing determines the energy of interaction; the binding energy between the acyl groups. Improved packaging results in a greater melting temperature or reduced solubility. Geometric isomerisation of a cis bond results in straightening the chain, and, in essence, behavior more similar to a saturated hydrocarbon chain. The glycerol mono elaidate has a melting point in between the glycerol monostearate and glycerol mono oleate.

Another consideration in this invention is the reverse of crystallization; the melting of the crystals that form to stabilize the liquid oil. It is useful for the crystals to have sufficient integrity to provide good stability during distribution and storage, but then possess the capability to melt rapidly during consumption by the consumer to allow good mouth feel and flavor release.

Mono- and diglycerides are formed in the intestinal tract as a result of the normal digestion of triglycerides and are also found naturally in minor amounts in all vegetable oils. As a result they are generally recognized as safe (GRAS). In particular, the diesters, which are quite lipophilic, can co-crystallize within the triglyceride network of the liquid vegetable oil. Monoesters of glycerides have reduced solubility in fats and begin to crystallize at even higher temperatures (e.g., 120°-130° F.), providing crystal seeding.

Mono- and diglycerides can be commercially prepared from edible fats and oils of animal or vegetable origin. The manufacturing process involves a reaction of fat (triglycerides) and glycerin or glycerol, typically in the presence of heat and a catalyst:

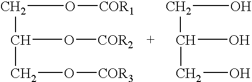

Thus, the above reaction, via heat and catalysis, yields triglycerides, 1,3-diglycerides, 1,2-diglycerides, 1-monoglycerides, 2-monglycerides, and glycerol. Selection for a monoglyceride fraction from the reaction, having properties as herein discussed, can be done without undue experimentation, from the knowledge in the art, and this disclosure, including documents cited herein or incorporated herein by reference. More specifically, the reaction is carried out at approximately 200° C. (392° F.) in the presence of a catalyst such as an alkaline catalyst (see, e.g., Lauridsen, supra; Feuge and Bailey: Modification of Vegetable Oils. VI. The Practical Preparation of Mono- and Diglycerides. Oil and Soap 23:259-264 (1946)). The reaction product is a mixture of mono- and diglycerides and triglycerides with minor quantities of free glycerol and free fatty acids, as depicted above and in Lauridsen, supra. The reaction mixture is then processed through to remove the remaining glycerol and to reduce the level of free fatty acids. The processing can comprise distillation. Thereafter, an acid is added to neutralize the catalyst. The degree of glycerolysis/interesterification upon equilibrium is determined by the ratio of triglycerides to glycerol.

Products from the foregoing reaction and/or mono- and diglyceride of the invention and useful in the practice of the invention contain, consist essentially of, or consist of a minimum monoglyceride content, by weight, of preferably greater than 45%, advantageously, greater than 70%, more preferably greater than 80%, and most advantageously greater than 90%. Products from the foregoing reaction and/or mono- and diglyceride of the invention and useful in the practice of the invention contain, consist essentially of, or consist of a content of glycerol mono elaidate (18:1 t ), by weight of, preferably 25-70%, advantageously, 40-70%, and more preferably 45-60%. Products from the foregoing reaction and/or mono- and diglyceride of the invention and useful in the practice of the invention contain, consist essentially of, or consist of a content of saturated monoglycerides (e.g., glycerol monostearate, glycerol monopalmitate, and combinations thereof), by weight, of preferably 10-40%, advantageously 15-35%, and more preferably 20-30%. Products from the foregoing reaction and/or mono- and diglyceride of the invention and useful in the practice of the invention contain, consist essentially of, or consist of a minimum monoglyceride content, by weight, of preferably greater than 45%, advantageously, greater than 70%, more preferably greater than 80%, and most advantageously greater than 90%, and a content of glycerol mono elaidate (18:1 t ), by weight of, preferably 25-70%, advantageously, 40-70%, and more preferably 45-60%, and a content of saturated monoglycerides (e.g., glycerol monostearate, glycerol monopalmitate, and combinations thereof), by weight, of preferably 10-40%, advantageously 15-35%, and more preferably 20-30%. Products meeting these specifications or employing these mono-and diglycerides, e.g., in a shortening system, for instance, in place of partially hydrogenated fats or oils, may be considered “conserved trans”. Such mono- and diglycerides are advantageously blended with oil, such as vegetable oil, e.g., unhydrogenated or non-hydrogenated and/or highly unsaturated vegetable oil, or otherwise employed as one employs mono-and diglycerides, for instance, as discussed herein.

When blended with oil, such as vegetable oil, e.g., unhydrogenated or non-hydrogenated and/or highly unsaturated vegetable oil, the system or composition may be considered a shortening system or composition. A shortening system or composition of the invention advantageously contains, by weight, 3-10%, advantageously 3-7%, preferably, 4-6%, such as 5%, of herein discussed mono-and diglycerides. The herein discussed mono- and di-glycerides provides stabilization of liquid oil in the shortening system, by the formation of a crystalline network that entrains and suspends liquid oil, thereby providing favorable mouth feel attributes, such as clean get a way, melt down, and flavor release. Shortening systems of the invention can allow for an ingredient declaration that avoids the listing of hydrogenated fats or oils or tropical fats, such as palm oil which are high in saturated fats, and can provide for the conservation of trans as well as saturated fats. Thus, the invention provides a shortening system comprising an admixture of at least one non hydrogenated vegetable oil and at lease one herein discussed mono-and diglyceride, advantageously obtained from the glycerolysis of a fat or oil. The invention can also provide a shortening system comprising an admixture of at least one hydrogenated vegetable oil and at least one herein mono- and diglyceride comprised predominantly of mono unsaturated acyl fatty acids (18:1 c & 18:1 t ) in combination with at least one saturated acyl fatty acids. In shortening systems of the invention, there can be plant fat selected from the group consisting of vegetable oils high in polyunsaturation, such as soybean oil or canola oil that have been partially and selectively hydrogenated. And, in shortening systems of the invention, the vegetable oil can selected from the group consisting of sunflower oil, soybean oil, corn oil, cottonseed oil, safflower oil, canola oil and olive oil.

As discussed herein the selective and partial hydrogenation of the unsaturated oil (to be subjected to glycerolysis/interesterification) is performed so as to result in conservation of the elaidic ester (C18:1t). Conditions required to provide such geometric isomer conservation are know to those skilled in the art. For example the selective and partial hydrogenation may be performed (i) at high catalyst concentration; (ii) at low hydrogen gas pressure; (iii) at high reaction temperature and/or (iv) utilizing a catalyst with reduced activity (poisoned with sulfur, for example). Processes in which selective and partial hydrogenation of unsaturated oils are taught can be found in, for example, U.S. Pat. No. 4,307,026 and “Foods, Fats and Oils”, Institute of Shortening and Edible Oils, 1750 New York Avenue, N.W., Suite 120, Washington, D.C. 20006. Such processes and the mechanisms by which they are controlled are taught in detail in the standard reference work Bailey's Industrial Oil and Fat Products, Wiley-lnterscience; 5th edition (December 1995), ISBN: 0-471-59430-X.

In one preferred aspect the selective and partial hydrogenation of the unsaturated oil (to be subjected to glycerolysis/interesterification) is performed so as to result in formation of elaidic ester (C18:1t).

In one preferred aspect the selective and partial hydrogenation of the unsaturated oil (to be subjected to glycerolysis/interesterification) is performed so as to result in formation of elaidic ester (C18:1t) and conservation of the elaidic ester (C18:1t).

Shortening systems of the invention can be used instead of conventional partially hydrogenated fats or oils in various types of foodstuffs or food products, and can be used as a delivery system for an emulsifier.

The invention is further described by, and a better understanding of the present invention and of its many advantages will be had from, the following examples, given by way of illustration.

### EXAMPLES

### Example 1: Cookie Dough

Fats and shortenings are incorporated in doughs to shorten the texture so that the finished products are less firm. During the mixture of a dough there is competition for the flour surface between the aqueous phase and the fat. The aqueous phase interacts with the flour protein to create gluten which forms a cohesive and extensible network. However when the surface of the flour is coated with fat, absorption is reduced and a less cohesive gluten network is formed. In this sense, the fat serves to shorten the texture.

To evaluate an inventive shortening containing liquid refined soybean oil (about 95% parts by weight) combined with mono- and diglyceride based on soybean oil (5 parts by weight; monoglyceride content 90% or greater, glycerol mono elaidate (18:1 t ) content 45-60%, saturated monoglycerides (glycerol monostearate, glycerol monopalmitate, and combinations thereof) content of 20-30%), a model formulation for sugar cookies is prepared. The shortening is prepared by thoroughly physically blending both components at a temperature of 60° C. to ensure complete solubilization of the mono- and diglyceride. The blend is then passed through a scrap surface heat exchanger and cooled to a temperature of approximately 24° C. and then tempered for 1 hour with gentle agitation to form a crystal network. The crystallized liquid shortening is then incorporated within the cookie dough formulation.

SUGAR COOKIE FORMULATION

| | INGREDIENTS | GRAMS |
|---|---|---|
| GROUP 1 | NFDM: NON-FAT DRY MILK POWDER | 2.25 |
| | SALT | 2.81 |
| | FGS: SUCROSE, FINE GRANULATION | 94.50 |
| | SODA: SODIUM BICARBONATE | 2.25 |
| | INVENTIVE SHORTENING SYSTEM | 90.00 |
| GROUP 2 | AMMONIUM BICARBONATE | 1.13 |
| | HFCS: HIGH FRUCTOSE CORN SYRUP | 3.38 |
| | WATER | 49.50 |
| GROUP 3 | FLOUR | 225.00 |

The mixing procedure for these Groups is as follows:

Stage 1

Group 1: blend dry ingredients (NFDM, salt, soda, FGS) add to fat, and mix in Hobart mixer 3 minutes at low speed, scrape paddle and sides of bowl after each minute of mixing.

Stage 2

Group 2: dissolve ammonium bicarbonate in tap water to form a first solution, add first solution to HFCS to form second solution, add second solution to product from Stage 1, follow Group 1 mixing procedure, mix 1 min at low speed, scraping bowl and paddle after each 30 sec., and mix 2 min at med. speed, scraping bowl and paddle after each 30 sec.

Stage 3

Group 3: add flour to product from Stage 2, follow Group 2 mixing procedure, fold into liquid mixture 3 times, and mix 2 minutes low speed, scraping bowl and paddle after each 30 sec.

After mixing is complete, the dough is allowed to sit for 10 minutes to observe oil retention.

Thereafter, the dough is sheeted out to a thickness of 7 mm with a rolling pin and gauge bars. Using a round cutter (60 mm), the cookies pieces are placed on an aluminum baking sheet and baked at 400° F. for 12 minutes.

After baking, the cookies are allowed to cool to ambient temperature.

The cookies are then evaluated for organoleptic properties (texture/flavor release) and oil retention.

Upon resting the mixed dough for 10 minutes, small amounts of liquid oil can be observed at the base of the pan. Even with this minor separation, the dough maintains good rheological properties for sheeting and cutting. The finished cookies have short texture and good flavor release. Negligible oil prints are from cookies on a paper towel overnight, similar to the prints left by a partially hydrogenated shortening.

### Example 2: Savory, Snack Crackers

Shortenings are employed both in the formulation of snack crackers and as a coating on the surface of the crackers after baking. Immediately after baking while the crackers are still hot, shortening (spray oil) is topically applied to the entire surface on a weight basis of 10-20%. This spray oil serves to improve and preserve the cracker's mouth profile concerning texture/flavor release; and, of course, its overall appearance. Generally, partially hydrogenated oils are employed as opposed to non-hydrogenated oils due to the presence of solid fat or crystals which entrap liquid oil. Crackers sprayed simply with non-hydrogenated oils can be characterized as very oily to the touch when removing from the packaging. In addition, the mouthfeel of these crackers seems somewhat dry and brittle and the flavor release seems quick as the liquid oil releases immediately from the surface.

To evaluate an inventive shortening composition as in Example 1, a model formulation for buttery snack crackers is prepared. The shortening is prepared by thoroughly physically blending both components at a temperature of 60° C. to ensure complete solubilisation of the mono-and diglyceride. The crackers are first formulated with the shortening and then after baking, the shortening is applied as a spray oil.

SAVORY SNACK CRACKER FORMULATION

| | INGREDIENTS | GRAMS |
|---|---|---|
| GROUP 1 | INVENTIVE SHORTENING SYSTEM | 30.00 |
| | SALT | 5.00 |
| | FGS: SUCROSE, FINE GRANULATION | 23.00 |
| | BUTTER FLAVOR | 2.00 |
| | HFCS: HIGH FRUCTOSE CORN SYRUP | 10.00 |
| | WATER | 160.00 |
| GROUP 2 | FLOUR | 500.00 |
| | SODIUM BICARBONATE | 6.00 |
| | CALCIUM PHOSPHATE | 4.00 |
| GROUP 3 | AMMONIUM BICARBONATE | 6.00 |

The mixing procedure for these Groups is as follows:

Stage 1

Group 1: In a water jacketed mixing bowl with paddle, add and mix all of Group 1 reserving a small portion of the water to dissolve ammonium bicarbonate. Mix for 3 minutes at low speed.

Stage 2

Group 2: Add flour, soda and calcium phosphate to the product from Stage 1, and jog mixer mix for 30 seconds at low speed.

Stage 3

Group 3: Add ammonium bicarbonate dissolved in remaining water to the product from Stage 2, and mix for 6-8 minutes at low speed; scraping down sides of mixing bowl after each 1 minute.

The sheeting and cutting and baking is as follows:

1. After proofing, the product from Stage 3 is sheeted on a Rondo Sheeter at #12 setting; and passed through 3 times. Thereafter, the product is sheeted once at the following settings, gradually reducing the thickness of the dough: #10, #7, #5 turn 9°, #3, finish at #1 or 3/4.

2. Stamp out cracker pieces so that 10 pieces weigh approximately 35 grams.

3. Place cracker pieces on hot wire mesh band. Bake at 400° F. for 4 minutes or until a golden brown color is obtained with a final moisture content of 2-3%

4. The inventive shortening system in spray oil form is then applied in liquid form at a temperature of 60° C. by a spray atomizer at a level of 18% based on a total weight of cracker.

5. The crackers are then allowed to cool on a rack and then packaged in plastic liners.

Upon evaluation, the crackers incorporating the inventive shortening based had a uniform appearance and were semi-dry to the touch. Both the mouthfeel and the flavor release provided a pleasant eating experience.

### Example 3: An Inventive Mono-and Diglyceride and Shortening System & Evaluation thereof

Partially hydrogenated soybean oil was subjected to glycerolysis followed by molecular distillation to obtain an inventive mono-and diglyceride having the following characteristics:

INVENTIVE MONO- &
DIGLYCERIDE CHARACTERISTICS
FATTY ACID COMPOSITION (weight percent)

| Myristic (C14:0) | Trace |
|---|---|
| Palmitic (C16:0) | 11.3% |
| Stearic (C18:0) | 13.4% |
| Oleic (C18:1) | 15.9% |
| Elaidic (C18:1t) | 56.0% |
| Linoleic (C18:2) | 2.3% |
| Arachidic (C20:0) | 0.3% |
| IODINE VALUE (wijs) | 60.3 |

OTHER PROPERTIES

| | |
|---|---|
| Acid Value (mg KOH/gram) | 0.96 |
| Total monoglyceride content (weight percent) | 95.5% |
| Total diglyceride (weight percent) | 2.8% |
| Free glycerol (weight percent) | 0.2% |
| Peroxide Value (Meq/kg) | 0.3 |

The above inventive mono-and diglyceride was formulated with fully refined soybean oil at levels of 3-6% (by weight) to obtain inventive shortening compositions or systems, i.e., the above mono- and diglyceride was admixed with fully refined soybean oil, such that the resultant shortening systems contained 3-6% by weight of the mono- and diglyceride.

The shortening systems were prepared as follows: fully refined soybean oil and the mono- and diglyceride were combined and heated to a temperature of 60° C. and mixed thoroughly to ensure the complete solubilisation of the mono- and diglyceride.

The shortening systems were evaluated as suitable for use as a shortening system, e.g., as a replacement for partially hydrogenated oil (see, e.g., Examples, infra) using the simulated cracker test: More in particular, using microscope slides to provide a surface to substitute for the surface of a cracker, the slide was dipped into the shortening system and removed, thereby forming a film of the shortening on the surface of the slide. The shortening system was then allowed to congeal on the surface of the slide and tempered for 1 day at 25° C. After tempering, the slides were then exposed to increasing higher temperatures to evaluate the integrity of the crystals and their ability to entrain the liquid oil.

The shortening systems performed quite satisfactorily in the simulated cracker test—the crystals maintained integrity and their ability to entrain liquid oil, demonstrating that the combination performs well as a shortening system, and that the inventive mono-and diglyceride can be employed in a shortening system that performs well (e.g., that the inventive shortening systems can provide improved organoleptic properties). The results show that these particular inventive compositions are useful in particular bakery formulations, such as those of Examples 1 and 2.

### Example 4: Nutritional Panel—Nabisco® Ritz® Crackers

Under the proposed guidelines for nutritional panel information including trans fat

| | | FAT SYSTEM: | FAT SYSTEM |
|---|---|---|---|
| | | FULLY REFINED | FULLY REFINED |
| | | SBO WITH 4% (BY | SBO WITH 6% (BY |
| | | WEIGHT) MONO- | WEIGHT) MONO- |
| | FAT SYSTEM: | AND DIGLYCERIDE | AND DIGLYCERIDE |
| | PARTIALLY | OF EXAMPLE 3; AN | OF EXAMPLE 3; AN |
| | HYDROGENATED | INVENTIVE | INVENTIVE |
| | SOYBEAN OIL | SHORTENING | SHORTENING |
| | (SBO) | SYSTEM | SYSTEM |
| Serving size | 16 grams | 16 grams | 16 grams |
| Total fat/serving | 4 grams | 4 grams | 4 grams |
| Saturated Fat | 1 gram | 0.6 grams | 0.62 grams |
| Trans Fat | 2 grams | 0.8 grams | 0.13 grams |
| Cis Monounsaturated fat | | 0.9 grams | 0.9 grams |
| Polyunsaturated fat | 1 gram | 2.5 grams | 2.3 grams |

### Example 5: Nutritional Panel—Nabisco® Triscuit® Crackers

Under the proposed guidelines for nutritional panel information including trans fat

| | | FAT SYSTEM: | FAT SYSTEM |
|---|---|---|---|
| | | FULLY REFINED | FULLY REFINED |
| | | SBO WITH 4% (BY | SBO WITH 6% (BY |
| | | WEIGHT) MONO- | WEIGHT) MONO- |
| | FAT SYSTEM: | AND DIGLYCERIDE | AND DIGLYCERIDE |
| | PARTIALLY | OF EXAMPLE 3; AN | OF EXAMPLE 3; AN |
| | HYDROGENATED | INVENTIVE | INVENTIVE |
| | SOYBEAN OIL | SHORTENING | SHORTENING |
| | (SBO) | SYSTEM | SYSTEM |
| Serving size | 29 grams | 29 grams | 29 grams |
| Total fat/serving | 5 grams | 5 grams | 5 grams |
| Saturated Fat | 1 gram | 0.8 grams | 0.78 grams |
| Trans Fat | 2 grams | 0.11 grams | 0.16 grams |
| Cis Monounsaturated fat | | 1.1 grams | 1.1 grams |
| Polyunsaturated fat | 1 gram | 3.0 grams | 2.9 grams |

### Example 6: Nutritional Panel—Nabisco® Original Flavor Wheat Thins®

Under the proposed guidelines for nutritional panel information including trans fat

| | | FAT SYSTEM: | FAT SYSTEM |
|---|---|---|---|
| | | FULLY REFINED | FULLY REFINED |
| | | SBO WITH 4% (BY | SBO WITH 6% (BY |
| | | WEIGHT) MONO- | WEIGHT) MONO- |
| | FAT SYSTEM: | AND DIGLYCERIDE | AND DIGLYCERIDE |
| | PARTIALLY | OF EXAMPLE 3; AN | OF EXAMPLE 3; AN |
| | HYDROGENATED | INVENTIVE | INVENTIVE |
| | SOYBEAN OIL | SHORTENING | SHORTENING |
| | (SBO) | SYSTEM | SYSTEM |
| Serving size | 29 grams | 29 grams | 29 grams |
| Total fat/serving | 6 grams | 6 grams | 6 grams |
| Saturated Fat | 1 gram | 0.92 grams | 0.94 grams |
| Trans Fat | 2 grams | 0.13 grams | 0.20 grams |
| Cis Monounsaturated fat | | 1.4 grams | 1.3 grams |
| Polyunsaturated fat | 0 gram | 3.6 grams | 3.5 grams |

### Example 7: Nutritional Panel—Keebler Townhouse Crackers®

Under the proposed guidelines for nutritional panel information including trans fat

| | | FAT SYSTEM: | FAT SYSTEM |
|---|---|---|---|
| | | FULLY REFINED | FULLY REFINED |
| | | SBO WITH 4% (BY | SBO WITH 6% (BY |
| | | WEIGHT) MONO- | WEIGHT) MONO- |
| | FAT SYSTEM: | AND DIGLYCERIDE | AND DIGLYCERIDE |
| | PARTIALLY | OF EXAMPLE 3; AN | OF EXAMPLE 3; AN |
| | HYDROGENATED | INVENTIVE | INVENTIVE |
| | SOYBEAN OIL | SHORTENING | SHORTENING |
| | (SBO) | SYSTEM | SYSTEM |
| Serving size | 16 grams | 16 grams | 16 grams |
| Total fat/serving | 4.5 grams | 4.5 grams | 4.5 grams |
| Saturated Fat | 1 gram | 0.65 grams | 0.66 grams |
| Trans Fat | 2 grams | 0.10 grams | 0.16 grams |
| Cis Monounsaturated fat | | 1.0 grams | 0.95 grams |
| Polyunsaturated fat | 1 gram | 2.5 grams | 2.4 grams |

Under the proposed guidelines for nutritional panel information including trans fat

| | | FAT SYSTEM: | FAT SYSTEM |
|---|---|---|---|
| | | FULLY REFINED | FULLY REFINED |
| | | SBO WITH 4% (BY | SBO WITH 6% (BY |
| | | WEIGHT) MONO- | WEIGHT) MONO- |
| | FAT SYSTEM: | AND DIGLYCERIDE | AND DIGLYCERIDE |
| | PARTIALLY | OF EXAMPLE 3; AN | OF EXAMPLE 3; AN |
| | HYDROGENATED | INVENTIVE | INVENTIVE |
| | SOYBEAN OIL | SHORTENING | SHORTENING |
| | (SBO) | SYSTEM | SYSTEM |
| Serving size | 30 grams | 30 grams | 30 grams |
| Total fat/serving | 6 grams | 6 grams | 6 grams |
| Saturated Fat | 1 gram | 0.92 grams | 0.94 grams |
| Trans Fat | 2 grams | 0.13 grams | 0.20 grams |
| Cis Monounsaturated fat | | 1.4 grams | 1.3 grams |
| Polyunsaturated fat | 0 gram | 3.6 grams | 3.5 grams |

### Example 8: Nutritional Panel—Nabisco® Nilla Wafers®

Examples 4-8 demonstrate that commercially available products made with inventive shortening systems have a more favorable fat profile, using the suggested nutritional panel; and that the invention can improve the fat content, e.g., trans fat content, of a foodstuff or the labeling or disclosure thereof, e.g., nutrition panel for the foodstuff, by substituting partially hydrogenated fat or oil of the foodstuff (currently employed in the preparation of the foodstuff) with a shortening system of the present invention. The current considerations of the US Food & Drug Administration (FDA) for a product nutritional panel is that any constituent less than 0.5/grams/serving does not require declaration; and thus, all of the inventive shortening systems with either 4 or 6% would provide a trans level below the declaration requirement.

The invention is further described by the following numbered paragraphs:

1. A shortening system that contains, or consists essentially of, or consists of, an unhydrogenated or non-hydrogenated, highly unsaturated, vegetable oil, e.g., sunflower oil, soybean oil, corn oil, cottonseed oil, safflower oil, canola oil, olive oil, or blends thereof, advantageously soybean oil, cottonseed oil, canola oil or blends thereof, and only a minor amount of a monoglyceride and/or diglyceride, advantageously a monoglyceride, based on a highly unsaturated oil, such as a highly unsaturated vegetable oil, e.g., canola or soybean oil, which has been selectively and partially hydrogenated so as to result in conservation of the geometric isomer of the C18:1 ester, namely the C18:1t or elaidic ester.

2. A method for preparing a shortening composition of paragraph 1 or as herein discussed by the physical blending or admixing of the components (e.g., the non-hydrogenated vegetable oil and the mono- and diglycerides or the stearine fraction thereof), preferably with mechanical agitation.

3. The method of paragraph 2 wherein the mono- and diglyceride is preferably heated to an elevated temperature sufficient to provide liquidity, e.g., to within plus or minus 10° C. of its melting point, and is then added directly into the oil, e.g., non-hydrogenated liquid vegetable oil.

4. The method of paragraph 3 wherein blending is continued until the mono- and diglyceride is completely in solution, e.g., completely dissolved into the non-hydrogenated liquid vegetable oil.

5. The use of an inventive shortening composition from paragraph 4 directly into a foodstuff at this temperature, or cooled prior to use in a foodstuff.

6. The use of an inventive shortening composition as a liquid, e.g., as a spray, or in an aerosol or atomized form.

7. The method of paragraph 4 further including, consisting essentially of, or consisting of, rapidly cooled to a temperature of about 65-90° F. (about 18°-32° C.) to initiate the formation of dispersed fat crystals in the oil prior to adding to other ingredients of a foodstuff.

8. The shortening system of any of the foregoing paragraphs containing, or consisting essentially of, or consisting of, a minor amount of the monoglyceride and/or diglyceride, such as, by weight (based on the total weight of the composition or system) about 3-about 10% or about 3-about 7% or about 4-about 6% or about 5%; or, less than 6-8% of the monoglyceride and/or diglyceride, for example, less approximately 6% or less than approximately 8%, such as from about 1% or about 2% or about 3% to about 5% or about 7% or less than 6% or less than 8%, e.g., about 2% or about 3% or about 4% to approximately 5%.

9. The shortening system of any of the foregoing paragraphs comprising, consisting essentially of, or consisting of, the oil or unsaturated or unhydrogenated or non-hydrogenated, and/or highly unsaturated and non-hydrogenated oil, in an amount by weight (based on the total weight of the composition or system), of more than 94-92%, or of about 97% to about 90%, or of about 97% to about 93%, or of about 96% to about 94%, or of about 95%, or of more than approximately 94%, or of more than approximately 92%; such as a system containing, or consisting essentially of, or consisting of, by weight (based on the total weight of the composition or system) from about 99% to about 95% of the oil, or, about 98% to about 95% of the oil, or, about 97% to about 95% of the oil, or, about 99% to about 93% of the oil, or, about 98% to about 93% of the oil, or, about 97% to about 93% of the oil, or about 96% to about 93% of the oil, or about 95% to about 93% of the oil, or, about 99% to about 94% of the oil, or, about 98% to about 94% of the oil, or, about 97% to about 94% of the oil, or of about 97% to about 95% of the oil; such as more than 92%, more than 94%, about 93%, e.g., about 99% or about 98% or about 97% or about 96% or approximately 95% oil.

10. The shortening system of any of the foregoing paragraphs containing less monoglyceride and/or diglyceride than the amount of the stearine fraction employed in shortening system of U.S. Pat. No. 5,908,655 and EP1057887A1.

11. The shortening system of any of the foregoing paragraphs wherein the oil and mono-and diglyceride are matched to each other; for instance, if the oil of the shortening system is canola oil, the mono- and diglyceride is based upon or of canola oil.

12. The shortening system of any of the foregoing paragraphs wherein mono-and diglyceride is advantageously obtained from the glycerolysis of a fat or oil.

13. The shortening system of any of the foregoing paragraphs which is a two-component system; namely that as a first component there is the oil and as a second component there is the mono-and diglyceride.

14. The shortening system of any of paragraphs 1-12 containing, consisting essentially of or consisting of additional ingredient or ingredients that are typically employed in shortening systems, with the understanding that such additional ingredient or ingredients are not to detract from the novel or basic characteristics of the invention and are not to extend to embodiments found in the prior art.

15. The shortening system of paragraph 14 which contains, consists essentially of or consists of as an antioxidant system, e.g., any desired antioxidant system, such as tocopherol, TBHQ, BHT, or propyl gallate, alone or in combination with metal scavengers such as citric acid, phosphoric acid, EDTA and the like, to increase the stability of the shortening system against oxidative reactions.

16. The shortening system of any of the foregoing paragraphs wherein the mono-and diglyceride comprises, or consists essentially of, or consists of, a minimum monoglyceride content of greater than about 45% by weight, such as greater than about 50% by weight, for instance, greater than about 55% by weight, e.g., greater than about 60% by weight, advantageously greater than about 65% by weight, preferably greater than about 70% by weight, such as greater than about 75% by weight, for instance, greater than about 80% by weight, e.g., greater than about 85% by weight, even more advantageously greater than about 90% by weight, e.g., greater than about 92% by weight, such as greater than about 95% by weight, most advantageously a product that is considered a monoglyceride.

17. The shortening system of paragraph 16 wherein the mono- and diglyceride contains, consists essentially of, or consists of a minimum monoglyceride content, by weight, of preferably greater than 45%, advantageously, greater than 70%, more preferably greater than 80%, and most advantageously greater than 90%.

18. The shortening system of any of the foregoing paragraphs wherein the mono-and diglyceride comprises, or consists essentially of, or consists of, a content of glycerol mono elaidate (18:t) by weight of about 25-about 70%, for instance, about 30-about 70%, such as about 35-about 70% or about 40-about 70% or about 45-about 70%; or, for example about 25-about 60%, such as about 30-about 60% or about 35-about 60%, advantageously about 40-about 60% or about 45-about 60%, such as about 50% or more than or greater than about 50%, e.g., up to about 70%.

19. The shortening system of paragraph 18 containing, consisting essentially of, or consisting of a content of glycerol mono elaidate (18:1 t ), by weight of, preferably 25-70%, advantageously, 40-70%, and more preferably 45-60%.

20. The shortening system of any of the foregoing paragraphs wherein the mono-and diglyceride comprises, or consists essentially of, or consists of, a content of saturated monoglycerides (e.g., glycerol monostearate, glycerol monopalmitate, and combinations thereof) by weight of about 10-about 40%, for instance, about 15-about 40%, such as about 20-about 40% or about 25-about 40% or about 25-about 30%; or, for example about 10 or about 15-about 35%, such as about 20-about 35% or about 25-about 35%, such as about 10 or about 15 or about 20-about 30% or about 25%.

21. The shortening system of paragraph 21 containing, consisting essentially of, or consisting of a content of saturated monoglycerides (e.g., glycerol monostearate, glycerol monopalmitate, and combinations thereof), by weight, of preferably 10-40%, advantageously 15-35%, and more preferably 20-30%.

22. A method for preparing a shortening composition comprising admixing an aforementioned mono-and diglyceride of any of the foregoing paragraphs, obtainable from or obtained from the glycerolysis/interesterification of a triglyceride, e.g., mono- and diglycerides from glycerolysis/interesterification having the aforementioned properties, with vegetable oil, advantageously an unhydrogenated or non-hydrogenated, highly unsaturated vegetable oil, e.g., sunflower oil, soybean oil, corn oil, cottonseed oil, safflower oil, canola oil, olive oil, or blends thereof, advantageously soybean oil, cottonseed oil, canola oil or blends thereof, advantageously soybean oil or canola oil.

23. A method for preparing a shortening system or composition comprising: subjecting a triglyceride to glycerolysis/interesterification; isolating a mono-and diglyceride obtainable from or obtained from the glycerolysis/interesterification of any of the foregoing paragraphs and/or having the aforementioned properties, and admixing the isolated monoglyceride and/or diglyceride obtainable from the glycerolysis/interesterification of a triglyceride with vegetable oil, e.g., sunflower oil, soybean oil, corn oil, cottonseed oil, safflower oil, canola oil, olive oil, or blends thereof, advantageously soybean oil, cottonseed oil, canola oil or blends thereof, advantageously soybean oil or canola oil.

24. An isolated mono-and diglyceride of any of the foregoing paragraphs and/or having the aforementioned properties, advantageously obtained from or obtainable from the glycerolysis/interesterification of a triglyceride.

25. An isolated mono-and diglyceride comprising, or consisting essentially of, or consisting of, a minimum monoglyceride content of greater than about 45% by weight, such as greater than about 50% by weight, for instance, greater than about 55% by weight, e.g., greater than about 60% by weight, advantageously greater than about 65% by weight, preferably greater than about 70% by weight, such as greater than about 75% by weight, for instance, greater than about 80% by weight, e.g., greater than about 85% by weight, even more advantageously greater than about 90% by weight, e.g., greater than about 92% by weight, such as greater than about 95% by weight, most advantageously a product that is considered a monoglyceride.

26. The isolated mono-and diglyceride of paragraph 25 wherein the mono- and diglyceride contains, consists essentially of, or consists of a minimum monoglyceride content, by weight, of preferably greater than 45%, advantageously, greater than 70%, more preferably greater than 80%, and most advantageously greater than 90%.

27. An isolated mono-and diglyceride comprising, or consisting essentially of, or consisting of, or an isolated mono-and diglyceride of paragraph 25 or 26 comprising, consisting essentially of or consisting of a content of glycerol mono elaidate (18:1t) by weight of about 25-about 70%, for instance, about 30-about 70%, such as about 35-about 70% or about 40-about 70% or about 45-about 70%; or, for example about 25-about 60%, such as about 30-about 60% or about 35-about 60%, advantageously about 40-about 60% or about 45-about 60%, such as about 50% or more than or greater than about 50%, e.g., up to about 70%.

28. The isolated mono-and diglyceride of paragraph 27 containing, consisting essentially of, or consisting of a content of glycerol mono elaidate (18:1 t ), by weight of, preferably 25-70%, advantageously, 40-70%, and more preferably 45-60%.

29. An isolated mono-and diglyceride containing, consisting essentially of, or consisting of, or an isolated mono- and diglyceride of any of paragraphs 25-28 comprising, or consisting essentially of, or consisting of, a content of saturated monoglycerides (e.g., glycerol monostearate, glycerol monopalmitate, and combinations thereof) by weight of about 10-about 40%, for instance, about 15-about 40%, such as about 20-about 40% or about 25-about 40% or about 25-about 30%; or, for example about 10 or about 15-about 35%, such as about 20-about 35% or about 25-about 35%, such as about 10 or about 15 or about 20-about 30% or about 25%.

30. An isolated mono-and diglyceride of paragraph 29 containing, consisting essentially of, or consisting of, a content of saturated monoglycerides (e.g., glycerol monostearate, glycerol monopalmitate, and combinations thereof), by weight, of preferably 10-40%, advantageously 15-35%, and more preferably 20-30%.

31. A shortening system comprising, or consisting essentially of, or consisting of, an admixture of at least one hydrogenated vegetable oil and at least monodiglyceride and/or diglyceride of any of the foregoing paragraphs and comprised predominantly of mono unsaturated acyl fatty acids (18:1c (cis) & 18:1t), in combination with at least one saturated acyl fatty acid.

32. The shortening system of paragraph 31, containing, consisting essentially of, or consisting of, based on weight of the total composition, about 3% to about 10% of the mono-and diglyceride, e.g., about 3% to about 7%, such as about 3% or about 4% or about 5% or about 6% of the mono-and diglyceride.

33. A shortening system of any of the foregoing paragraphs wherein the vegetable oils is high in polyunsaturation, such as soybean oil, canola oil

34. A shortening system of any of the foregoing paragraphs wherein the oil has been partially and selectively hydrogenated may be employed.

35. Use of a shortening system of any of the foregoing paragraphs in a foodstuff or use of a mono-and diglyceride of any of the foregoing paragraphs in a shortening system which is used in a foodstuff.

36. A foodstuff or food product, such as bread, a cracker, cookie or similar baked food product or good that contains or has been coated with a shortening system of any of the foregoing paragraphs.

37. A method for preparing such a foodstuff or food product comprising, consisting essentially of or consisting of coating the foodstuff or food product with a shortening system of any of the foregoing paragraphs.

38. An improved method for preparing such a foodstuff or food product comprising or consisting essentially of or consisting of coating the foodstuff or food product with or topically applying to the foodstuff or food product a shortening system as in any of the foregoing paragraphs.

39. An improved method for improving or increasing shelf life or for improving or enhancing organoleptic properties or mouthfeel or taste of a foodstuff or food product comprising or consisting essentially of or consisting of coating the foodstuff with or topically applying to the foodstuff or food product a shortening system of any of the foregoing paragraphs.

40. A method as in any of paragraphs 37-39 wherein the coating or topical application is performed after baking the foodstuff or food product, and prior to any packaging.

41. An improvement in the preparation and packaging of such a foodstuff or food product is coating the foodstuff or food product with, or topically applying to the foodstuff or food product, after baking and before packaging, a shortening system of any of the foregoing paragraphs.

42. A foodstuff containing, coated with, or baked with a shortening system or mono-and diglyceride of any of the foregoing paragraphs.

43. A delivery system for an emulsifier comprising, consisting essentially of, or consisting of, the shortening system of any of the foregoing paragraphs and an emulsifier.

44. The delivery system of paragraph 43 wherein the emulsifier is a food emulsifier.

45. The delivery system of paragraph 44 wherein the emulsifier is lecithin, Diacetylated tartaric acid esters of mono-diglycerides (DATEM), and sodium stearoyl lactylate (SSL).

46. An isolated monoglyceride and/or diglyceride obtained or obtainable by glycerolysis/interesterification of an unsaturated oil which has been selectively and partially hydrogenated so as to result in conservation of the elaidic ester (C18:1t).

47. An isolated monoglyceride and/or diglyceride according to paragraph 46, wherein the content of monoglyceride is greater than about 45% by weight.

48. An isolated monoglyceride and/or diglyceride according to paragraph 46 or 47, wherein the content of monoglyceride is greater than about 75% by weight.

49. An isolated monoglyceride and/or diglyceride according to paragraph 46, 47 or 48 wherein the content of monoglyceride is greater than about 95% by weight.

50. An isolated monoglyceride and/or diglyceride according to any one of the preceding paragraphs wherein the content of glycerol mono elaidate (18:1t) is from 25% to 70% by weight.

51. An isolated monoglyceride and/or diglyceride according to any one of the preceding paragraphs wherein the content of glycerol mono elaidate (18:1t) is from 40% to 70% by weight.

52. An isolated monoglyceride and/or diglyceride according to any one of the preceding paragraphs wherein the content of glycerol mono elaidate (18:1t) is from 45% to 60% by weight.

53. An isolated monoglyceride and/or diglyceride according to any one of the preceding paragraphs comprising saturated monoglycerides.

54. An isolated monoglyceride and/or diglyceride according to paragraph 53 wherein the content of saturated monoglycerides is from 10% to 40% by weight.

55. An isolated monoglyceride and/or diglyceride according to paragraph 53 or 54 wherein the content of saturated monoglycerides is from 15% to 35% by weight.

56. An isolated monoglyceride and/or diglyceride according to paragraph 53, 54 or 55 wherein the content of saturated monoglycerides is from 20% to 30% by weight.

57. An isolated monoglyceride and/or diglyceride according to any one of paragraphs 53 to 56 wherein the saturated monoglycerides are selected from the group consisting of glycerol monostearate, glycerol monopalmitate and combinations thereof.

58. An isolated monoglyceride and/or diglyceride according to any one of the preceding paragraphs, wherein the unsaturated oil is an unsaturated vegetable oil.

59. An isolated monoglyceride and/or diglyceride according to paragraph 58, wherein the highly unsaturated vegetable oil is selected from the group consisting of canola oil and soybean oil.

60. A process for the preparation of a monoglyceride and/or diglyceride comprising the steps of
(i) selective and partial hydrogenation of an unsaturated oil so as to result in conservation of the elaidic ester (C18:1t)
(ii) glycerolysis/interesterification of the selectively and partially hydrogenated unsaturated oil.

61. A monoglyceride and/or diglyceride obtainable in accordance with a process as defined in paragraph 60.

62. A monoglyceride and/or diglyceride obtained in accordance with a process as defined in paragraph 60.

63. A shortening system comprising
i) an edible oil; and
ii) a monoglyceride and/or diglyceride obtained or obtainable by glycerolysis/interesterification of an unsaturated oil which has been selectively and partially hydrogenated so as to result in conservation of the elaidic ester (C18:1t);
wherein the monoglyceride and/or diglyceride is present in a minor amount.

64. A shortening system according to paragraph 63 wherein the edible oil is a vegetable oil.

65. A shortening system according to paragraph 64 wherein the edible oil is a vegetable oil selected from the group consisting of sunflower oil, soybean oil, corn oil, cottonseed oil, safflower oil, canola oil, olive oil and blends thereof.

66. A shortening system according to paragraph 64 or 65 wherein the edible oil is a vegetable oil selected from the group consisting of soybean oil, cottonseed oil, canola oil and blends thereof.

67. A shortening system according to any one of paragraphs 63 to 66 wherein the edible oil is a hydrogenated oil.

68. A shortening system according to any one of paragraphs 63 to 66 wherein the edible oil has been partially and selectively hydrogenated.

69. A shortening system according to any one of paragraphs 63 to 66 wherein the edible oil is unhydrogenated.

70. A shortening system according to paragraph 69 wherein the edible oil is an unhydrogenated, unsaturated, vegetable oil.

71. A shortening system according to any one of paragraphs 63 to 70, wherein the monoglyceride and/or diglyceride is present in an amount of approximately 5% by weight of the shortening system.

72. A shortening system according to any one of paragraphs 63 to 71, wherein the monoglyceride and/or diglyceride is present in an amount of less than about 8% by weight of the shortening system.

73. A shortening system according to any one of paragraphs 63 to 72, wherein the edible oil is present in an amount of more than 92% by weight of the shortening system.

74. A shortening system according to any one of paragraphs 63 to 73, wherein the edible oil is present in an amount of approximately 95% by weight of the shortening system.

75. A shortening system according to any one of paragraphs 63 to 74 wherein the edible oil and monoglyceride and/or diglyceride are matched to each other.

76. A shortening system according to any one of paragraphs 63 to 75 wherein the monoglyceride and/or diglyceride is as defined in any one of paragraphs 46 to 59.

77. A shortening system according to any one of paragraphs 63 to 76 further comprising one or more additional ingredients that are typically employed in shortening systems.

78. A shortening system according to paragraph 77, further comprising an antioxidant system and/or a metal scavenger.

79. A shortening system according to paragraph 78 wherein the antioxidant system is selected from the group consisting of tocopherol, TBHQ, BHT, propyl gallate and combinations thereof.

80. A shortening system according to paragraph 78 or 79, wherein the metal scavenger is selected from the group consisting of citric acid, phosphoric acid, EDTA and combinations thereof.

81. A shortening system according to any one of paragraphs 63 to 80 wherein the shortening system is a liquid.

82. A shortening system according to paragraph 81, wherein the shortening system is in the form of a spray, or in an aerosol or in an atomized form.

83. A method for preparing a shortening system as defined in any one of paragraphs 63 to 82, wherein the method comprises the step of physically blending or admixing the components, preferably with mechanical agitation.

84. A method according to paragraph 83 wherein the monoglyceride and/or diglyceride is heated to a temperature sufficient to provide liquidity and is then added directly into the edible oil.

85. A method according to paragraph 84 wherein the temperature sufficient to provide liquidity is within plus or minus 10° C. of the melting point of the monoglyceride and/or diglyceride.

86. A method according to any one of paragraphs 83 to 85, wherein the blending or admixing is continued until the monoglyceride and/or diglyceride has completely dissolved in the edible oil.

87. A method according to any one of paragraphs 84 to 86, further comprising the step of rapidly cooling the shortening system to a temperature of about 180 to 32° C. prior to use.

88. A method of preparing a foodstuff, comprising the step of contacting the foodstuff with a shortening system as defined in any one of paragraphs 63 to 82.

89. A method according to paragraph 88, wherein the shortening system reaches an elevated temperature during its preparation and is not cooled before being contacted with the foodstuff.

90. A method according to paragraph 88, wherein the shortening system reaches an elevated temperature during its preparation and is rapidly cooled before being contacted with the foodstuff.

91. A method according to any one of paragraphs 88 to 90 wherein the foodstuff is a baked foodstuff.

92. A method according to paragraph 91 wherein the foodstuff is bread, a cracker or a cookie.

93. A method according to any one of paragraphs 88 to 92, wherein the foodstuff is coated with the shortening system or the shortening system is topically applied to the foodstuff.

94. A method according to paragraph 93, wherein the foodstuff is a baked foodstuff and wherein the coating or topical application is performed after baking the foodstuff and prior to packaging the foodstuff.

95. A foodstuff prepared by the method of any one of paragraphs 88 to 94.

96. A method for modifying, preferably improving the fat content of a foodstuff comprising substituting partially hydrogenated fat or oil of the foodstuff with a shortening system as defined in any one of paragraphs 63 to 82.

97. Use of a shortening system as defined in any one of paragraphs 63 to 82, for improving or increasing the shelf-life of a foodstuff.

98. Use of a shortening system as defined in any one of paragraphs 63 to 82 for improving or enhancing organoleptic properties or mouthfeel or taste of a foodstuff.

99. Use of a monoglyceride and/or diglyceride as defined in any one of paragraphs 46 to 59 in the preparation of a foodstuff.

100. A delivery system for an emulsifier comprising a shortening system as defined in any one of paragraphs 63 to 82 and an emulsifier.

101. A delivery system according to paragraph 55, wherein the emulsifier is a food emulsifier.

102. A delivery system according to paragraph 55 or 56, wherein the emulsifier is selected from the group consisting of lecithin, diacetylated tartaric acid esters of mono-diglycerides (DATEM), sodium stearoyl lactylate (SSL) and combinations thereof.

103. A method for improving the fat content, e.g., trans fat content, of a foodstuff or the labeling or disclosure thereof, e.g., nutrition panel for the foodstuff, comprising, consisting essentially of, or consisting of, substituting partially hydrogenated fat or oil of the foodstuff with a shortening system of any of the foregoing paragraphs.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

1. An isolated monoglyceride and/or diglyceride obtained or obtainable by glycerolysis/interesterification of an unsaturated oil which has been selectively and partially hydrogenated so as to result in conservation of the elaidic ester (C18:1t).

2. An isolated monoglyceride and/or diglyceride according to claim 1, wherein the content of monoglyceride is greater than about 45% by weight.

3. An isolated monoglyceride and/or diglyceride according to claim 1, wherein the content of monoglyceride is greater than about 75% by weight.

4. An isolated monoglyceride and/or diglyceride according to claim 1, wherein the content of monoglyceride is greater than about 95% by weight.

5. An isolated monoglyceride and/or diglyceride according to claim 1, wherein the monoglyceride and/or diglyceride has a glycerol mono elaidate (18:1t) content from 25% to 70% by weight.

6. An isolated monoglyceride and/or diglyceride according to claim 1, wherein the monoglyceride and/or diglyceride has a glycerol mono elaidate (18:1t) content from 40% to 70% by weight.

7. An isolated monoglyceride and/or diglyceride according to claim 1, wherein the monoglyceride and/or diglyceride has a glycerol mono elaidate (18:1t) content from 45% to 60% by weight.

8. An isolated monoglyceride and/or diglyceride according to claim 1, comprising saturated monoglycerides.

9. An isolated monoglyceride and/or diglyceride according to claim 8, wherein the content of saturated monoglycerides is from 10% to 40% by weight.

10. An isolated monoglyceride and/or diglyceride according to claim 8, wherein the content of saturated monoglycerides is from 15% to 35% by weight.

11. An isolated monoglyceride and/or diglyceride according to claim 8, wherein the content of saturated monoglycerides is from 20% to 30% by weight.

12. An isolated monoglyceride and/or diglyceride according to claim 8, wherein the saturated monoglycerides are selected from the group consisting of glycerol monostearate, glycerol monopalmitate and combinations thereof.

13. An isolated monoglyceride and/or diglyceride according to claim 1, wherein the unsaturated oil is an unsaturated vegetable oil.

14. An isolated monoglyceride and/or diglyceride according to claim 13, wherein the unsaturated vegetable oil is selected from the group consisting of canola oil and soybean oil.

15. A process for the preparation of a monoglyceride and/or diglyceride comprising the steps of
(i) selective and partial hydrogenation of an unsaturated oil so as to result in conservation of the elaidic ester (C18:1t)
(ii) glycerolysis/interesterification of the selectively and partially hydrogenated unsaturated oil.

16. A monoglyceride and/or diglyceride obtainable in accordance with a process as defined in claim 15.

17. A monoglyceride and/or diglyceride obtained in accordance with a process as defined in claim 15.

18. A shortening system comprising
i) an edible oil; and
ii) a monoglyceride and/or diglyceride obtained or obtainable by glycerolysis/interesterification of an unsaturated oil which has been selectively and partially hydrogenated so as to result in conservation of the elaidic ester (C18:1t);
wherein the monoglyceride and/or diglyceride is present in a minor amount.

19. A shortening system according to claim 18, wherein the edible oil is a vegetable oil.

20. A shortening system according to claim 19, wherein the edible oil is a vegetable oil selected from the group consisting of sunflower oil, soybean oil, corn oil, cottonseed oil, safflower oil, canola oil, olive oil and blends thereof.

21. A shortening system according to claim 19, wherein the edible oil is a vegetable oil selected from the group consisting of soybean oil, cottonseed oil, canola oil and blends thereof.

22. A shortening system according to claim 18, wherein the edible oil is a hydrogenated oil.

23. A shortening system according to claim 18, wherein the edible oil has been partially and selectively hydrogenated.

24. A shortening system according to claim 18, wherein the edible oil is unhydrogenated.

25. A shortening system according to claim 24 wherein the edible oil is an unhydrogenated, unsaturated, vegetable oil.

26. A shortening system according to claim 18, wherein the monoglyceride and/or diglyceride is present in an amount of approximately 5% by weight of the shortening system.

27. A shortening system according to claim 18, wherein the monoglyceride and/or diglyceride is present in an amount of less than about 8% by weight of the shortening system.

28. A shortening system according to claim 18, wherein the edible oil is present in an amount of more than 92% by weight of the shortening system.

29. A shortening system according to claim 18, wherein the edible oil is present in an amount of approximately 95% by weight of the shortening system.

30. A shortening system according to claim 18, wherein the edible oil and monoglyceride and/or diglyceride are matched to each other.

31. A shortening system according to claim 18, wherein the monoglyceride and/or diglyceride is obtained or obtainable by glycerolysis/interesterification of an unsaturated oil which has been selectively and partially hydrogenated so as to result in conservation of the elaidic ester (C18:1t).

32. A shortening system according to claim 18, further comprising one or more additional ingredients that are typically employed in shortening systems.

33. A shortening system according to claim 32, further comprising an antioxidant system and/or a metal scavenger.

34. A shortening system according to claim 33, wherein the antioxidant system is selected from the group consisting of tocopherol, TBHQ, BHT, propyl gallate and combinations thereof.

35. A shortening system according to claim 33, wherein the metal scavenger is selected from the group consisting of citric acid, phosphoric acid, EDTA and combinations thereof.

36. A shortening system according to claim 18, wherein the shortening system is a liquid.

37. A shortening system according to claim 36, wherein the shortening system is in the form of a spray, or in an aerosol or in an atomized form.

38. A method for preparing a shortening system as defined in claim 18, wherein the method comprises the step of physically blending or admixing the components, preferably with mechanical agitation.

39. A method according to claim 38, wherein the monoglyceride and/or diglyceride is heated to a temperature sufficient to provide liquidity and is then added directly into the edible oil.

40. A method according to claim 39, wherein the temperature sufficient to provide liquidity is within plus or minus 10° C. of the melting point of the monoglyceride and/or diglyceride.

41. A method according to claim 38, wherein the blending or admixing is continued until the monoglyceride and/or diglyceride has completely dissolved in the edible oil.

42. A method according to claim 39, further comprising the step of rapidly cooling the shortening system to a temperature of about 18° to 32° C. prior to use.

43. A method of preparing a foodstuff, comprising the step of contacting the foodstuff with a shortening system as defined in claim 18.

44. A method according to claim 43, wherein the shortening system reaches an elevated temperature during its preparation and is not cooled before being contacted with the foodstuff.

45. A method according to claim 43, wherein the shortening system reaches an elevated temperature during its preparation and is rapidly cooled before being contacted with the foodstuff.

46. A method according to claim 43, wherein the foodstuff is a baked foodstuff.

47. A method according to claim 46, wherein the foodstuff is bread, a cracker or a cookie.

48. A method according to claim 43, wherein the foodstuff is coated with the shortening system or the shortening system is topically applied to the foodstuff.

49. A method according to claim 48, wherein the foodstuff is a baked foodstuff and wherein the coating or topical application is performed after baking the foodstuff and prior to packaging the foodstuff.

50. A foodstuff prepared by the method of claim 43.

51. A method for modifying, preferably improving the fat content of a foodstuff comprising substituting partially hydrogenated fat or oil of the foodstuff with a shortening system as defined in claim 18.

52. Use of a shortening system as defined in claim 18, for improving or increasing the shelf-life of a foodstuff.

53. Use of a shortening system as defined in claim 18, for improving or enhancing organoleptic properties or mouthfeel or taste of a foodstuff.

54. Use of a monoglyceride and/or diglyceride as defined in claim 1, in the preparation of a foodstuff.

55. A delivery system for an emulsifier comprising a shortening system as defined in claim 18 and an emulsifier.

56. A delivery system according to claim 55, wherein the emulsifier is a food emulsifier.

57. A delivery system according to claim 55, wherein the emulsifier is selected from the group consisting of lecithin, diacetylated, tartaric acid esters of mono-diglycerides (DATEM), sodium stearoyl lactylate (SSL) and combinations thereof.
